(19) United States
(12) Patent Application Publication
(10) Pub. No.: US 2014/0371373 A1
(43) Pub. Date: Dec. 18, 2014

(54) Components Manufactured from Plastics Material for Systems to Fix Rails for Railway Vehicles

(71) Applicant: Vossloh-Werke GmbH, Wordohl (DE)

(72) Inventors: Michael Harrass, Wuppertal (DE); Dietmar Becker, Iserlohn (DE); Bernd Schulte, Ludenscheid (DE)

(73) Assignee: Vossloh-Werke GmbH, Werdohl (DE)

(21) Appl. No.: 14/374,415

(22) PCT Filed: Jan. 18, 2013
(86) PCT No.: PCT/EP2013/050987

§ 371 Date: Jul. 24, 2014

(30) Foreign Application Priority Data
Jan. 26, 2012 (DE) 10 2012 001 419.8

(51) Int. Cl. C08K 7/14; E01B 13/00; E01B 9/62; E01B 9/00

(52) U.S. Cl. CPC C08K 7/14; E01B 9/00; E01B 13/00; E01B 9/62; C08K 2201/004
USPC 524/494; 238/287; 238/283

(57) ABSTRACT

The present invention relates to a component for rail fixing systems manufactured from a fibre-reinforced plastics material which consists of a basic plastics material and reinforcement fibres integrated therein. The component for rail fixing systems according to the invention can be manufactured from plastics materials in a cost-effective manner and combines a low weight with a mechanical resilience optimally matching the requirements with the greatest possible level of design freedom. This is achieved by manufacturing the component by using injection moulding compounding and the length of the reinforcement fibres being an average of at least 200 μm.

The invention relates to components manufactured from plastics material for systems to fix rails for railway vehicles.

Modern rail fixings which in particular are used in heavy goods vehicles or on high-speed lines, regularly comprise various components manufactured from plastics materials which are used to support and guide the rails to be fixed.

Components of the type in question here may for example be plate-shaped. These plate-shaped components for fixing rails include plates known in technical language as “steering plates”, “angled guide plates”, “packing plates”, “spacer plates”, “pressure distribution plates” and “ribbed plates”.

In fully assembled fixing systems, steering plates support the rails to be fixed laterally and absorb the transverse forces which occur the fixing point in question is driven over. Furthermore, each steering plate can be used as a support for a spring element which exerts the required elastic down-holding forces on the rail foot to hold down the rail when the system is fully assembled. To this end, one or a plurality of moulded parts may be formed on the free upper side of the steering plates when the system is fully assembled, in or on which the respective spring element is guided such that it retains its target position even under the loads which occur in practice. The moulded elements in question may be indentations such as grooves, holes or other recesses or depressions in which the spring element or a tensioning means provided to tension the spring element sits at least in part when the system is fully assembled. Furthermore, the moulded parts can be formed as ribs, webs or other elevations against the principal planes of the surface of the steering plate, on which moulded parts the spring element is supported in the manner of abutments or laterally guided.

If the steering plate is formed as an “angled guide plate” then an indent which extends in a longitudinal direction of the steering plate is additionally formed on the underside of the steering plate, which indent sits in an interlocking manner in a correspondingly formed recess of the subsoil when assembled. In this way, the position of the steering plate is fixed transverse to the longitudinal extension of the rails.

Packing plates, spacer plates, pressure distribution plates and ribbed plates are used with rail fixing systems of the type in question in order to transfer the loads which occur when driving over the fastening point formed by a fixing system of this type in the direction of gravity over a wide area and evenly over the subsoil on which the fixing point is constructed. Dependent on the local conditions and their assembly position within the respective rail fixing system, for this purpose they extend at least over the width of the rail foot measured transverse to the longitudinal extension of the rail or extend laterally beyond this. The plates in question then either lie directly on the subsoil in question or are supported by one or a plurality of intermediate layers on the subsoil. Packages of a plurality of layers are also formed from different plates and intermediate layers consisting of elastic material, through which a, on the one hand even distribution of the loads which occur and on the other hand the required elasticity for a long lifetime of the rail to be fixed, required elastic resilience of the fixing point in the direction of gravity is ensured.

Ribbed plates are a special case for the plate-shaped components for rail fixings. On their free upper side when assembled two ribs which are aligned parallel to one another and extend in a longitudinal direction to the rail to be fixed, which ribs between them define the contact surface on which the rail to be fixed stands with its rail foot when it is assembled. The ribs are spaced from one another such that they guide the rail foot laterally and absorb the transverse forces which occur when driving over the fixing point formed by the respective rail fixing system.

In addition to the plate-shaped components, dependent on the respective local conditions or the technical requirements of the relevant rail fixing, for example insulation elements consisting of plastics material are required. These insulation elements are used to insulate the components of the fixing system in each case consisting of conductive material or the rail to be fixed itself from the subsoil on which the rail is fixed.

Adapters or eccentric bodies made of plastics material can also be used in rail fixings in order to adjust the position of the rail to be fixed for the purpose of adapting the track gauge of the track which is associated with the rail to be fixed.

Regardless of which of the elements mentioned above it is, during practical use the components of a rail fixing system consisting of plastics material must not only tolerate the high static and dynamic loads which occur when driving over the respective fixing point, but they must also be robust against abrasive wear and must not be sensitive to temperature changes, liquids and other environmental factors.

At the same time, the components of a rail fixing system consisting of plastics material should have a low weight and high dimensional stability. To this end, for example recesses are formed into the underside of the plate element which is associated with the respective subsoil on which the rail fixing system is to be constructed and a rib structure is designed.

By exploiting all possible design possibilities, a filigree design of modern plate components results which is characterised by locally minimised wall thicknesses and frequent changes in wall thickness which set high requirements in terms of product engineering.

In order to meet the requirements set for its resilience, plastics materials reinforced with glass fibres are used in the prior art for components which are used in rail fixings.

Since on the one hand there are demands for minimized manufacturing costs and on the other hand the requirements which are placed on the mechanical properties of components of rail fixing systems of the type in question here which are manufactured from plastics materials are continually increasing, the object of the invention was to create a component for rail fixing systems which can be manufactured from plastics materials in a cost-effective manner and which combines a low weight with a mechanical resilience optimally matching the requirements with the greatest possible level of design freedom.

In accordance with the invention, this object is achieved by a component with the features specified in Claim 1.

Advantageous embodiments and variants of the invention are given in the dependent claims and are explained in greater detail below along with the general concept of the invention.

A component according to the invention is therefore manufactured from a fibre-reinforced plastics materials which consists of a basic plastics material and reinforcement fibres integrated therein. In accordance with the invention, the manufacturing takes place using injection moulding compounding, wherein in accordance with the invention the length of the reinforcement fibres provided in the completed component is at least 200 μm on average.

Where mention is made to the “average of the lengths”, this always means the mean value which is generally calculated by simply dividing the overall length of the fibres determined in a sample by the number of fibres in the sample.

In principle, all thermoplastic plastics materials can be used as basic plastics materials for a component according to the invention. This particularly includes polypropylene (PP), polyamide (PA), polyethylene terephthalate (PET), polyoxymethylene (POM), acrylonitrile-butadiene styrene (ABS), polybutylene terephthalate (PBT), polyethylene (LDPE/HDPE) and mixtures thereof as well as for example blends or compounds.

In accordance with the invention, particularly highly resilient, filigree-shaped components made of plastics materials are manufactured for rail fixing systems using injection moulding compounding. This method is also known as the “IMC method”. As stated in the article by M. SIEVERDING, DR. E. BÜRKLE, R. ZIMMET “IMC-Technik erschlieβt neue Anwendungsbereiche” (“IMC technique unlocks new areas of application”), Kunststoffe 8/2005, Carl Hanser Publishing House, Munich, the IMC method enables the manufacture of reinforced high volume components in which the advantages of injections moulding and extrusion are combined with one another. The special feature of the IMC method is that a dual screw extruder is used through which in the process the desired material mixture can be compounded individually. In this way, in order to develop or optimise certain characteristics directly during the processing, for example reinforcement fibres, fillers or plastics material additives in the form of granules, so called “masterbatches”, can be added to the basic plastics materials, the contents of which masterbatches have a higher amount of colourants or additives than the final application.

Surprisingly, it has been shown that using the IMC method according to the invention to manufacture fibre-reinforced plastics material components for rail fixings it is possible to obtain considerably longer reinforcement fibre lengths in the complete components than is possible in the conventional manufacture of components for rail fixing from fibre-reinforced plastics material granules.

In the case in point here, “components for rail fixings”, longer lengths of the reinforcement fibres integrated into the basic material primarily mean higher stability in the component in question. Furthermore, there are advantages of the longer reinforcement fibres enabled by using the IMC method according to the invention in that for the same volume a lower number of reinforcement fibres is required to achieve the desired mechanical values. From a manufacturing technology perspective, there is a particular advantage here in that with a lower number of reinforcement fibres the abrasive tool wear is reduced considerably because only the end portions of the fibres which touch the wall of the tool have an abrasive effect.

It was shown that the length of the reinforcement fibres in plate-shaped components of the type described above manufactured according to the invention using the IMC method was regularly at least 25% longer than for identically formed components which were produced from conventional granules, wherein the reinforcement fibres were added in the granule production. It was shown that the average fibre length of plate elements produced according to the invention was regularly at least equal to twice the average length of fibres found in conventionally manufactured components.

Specifically, certain plate components such as steering plates, packing plates, spacer plates, pressure distribution plates and ribbed plates can be produced according to the invention for fixing rails using the IMC method, in which the reinforcement fibre lengths are on average at least 200 μm or above, in particular at least 300 μm or above. In practical tests, reinforcement fibre lengths could regularly be achieved which were on average greater than 350 μm, wherein the reinforcement fibre lengths attained were in the range from 15-2000 μm, in particular 20-2000 μm.

A considerable advantage in terms of the regularity of the property distribution of components according to the invention is that in components produced according to the invention for rail fixings the dispersion of the fibre lengths is minimised. In this way, there is a particularly small distribution curve for the lengths of the reinforcement fibres.

For example, conventional glass fibres are introduced into the respective basic plastics material as reinforcement fibres according to the invention. It is, however, also possible to add other high-performance fibres to the basic plastics material in a manner according to the invention. In addition to aramid and carbon fibre materials, this also includes, for example, metal and ceramic fibres.

In order to ensure the wetting with the basic plastics material, the reinforcement fibres introduced in the IMC process according to the invention can be provided with a sizing which works in the manner of an adhesion agent. This includes, for example, mechanically, adhesively and chemically acting sizings, such as polyurethane and silane.

When using the IMC method according to the invention, an improved integration of the reinforcement fibres into the polymer matrix of the basic plastics material is enabled through the coating with a sizing of this type.

The addition of chopped fibreglass fibres (short and long glass) or glass balls as a hybrid reinforcement material as a bulk material is also possible.

A particularly filigree design of the components according to the invention is enabled by the raw material properties improved by using the IMC method according to the invention. In this way, finely organised ribbings can be formed which lead to a considerable material saving without the mechanical properties, in particular the component strength and inherent stability suffering as a result. In general, plastics material can be saved as a result of using the IMC method due to the improved plastics material, since the required stability is achieved even at minimised component volume. In this way, a reduction of the component volume by up to 25% compared to the volume of conventionally manufactured components can be achieved by consistent use of the opportunities which open up as a result of the use of the IMC method according to the invention.

The properties, which are specially required for practical use of components for rail fixings according to the invention, can be adjusted with the addition of additives and fillers. In this way, components according to the invention of a low weight and with optimal mechanical properties can be manufactured from plastics material in a cost-efficient manner by additives and fillers being added in a targeted manner to the basic plastics material used, through which properties can be modified in a targeted manner such as,
the type and the influence of crystallinity (suitable additives for this are known crystallisation formers used in the prior art for this purpose, such as finely dispersed particles e.g. silicic acid),
resistance to weather conditions (suitable additives for this are known antioxidants or soot used in the prior art for this purpose),
the mechanical resistibility (suitable additives for this are reinforcement fibres or reinforcement particles),
the thermal properties (suitable additives for this are known heat stabilisers used in the prior art for this purpose),
the electrical properties (suitable additives for this are electrically conductive metal particles which give the plastics material a certain level of conductivity).
the tribological properties (suitable additives for this are known lubricants such as MoS2 or graphite which can be stored in the plastics material and are used in the prior art for this purpose),
the fire behaviour (suitable additives for this are known flame retardant materials such as halogen or aluminium compounds),
the hygroscopy (suitable additives are known hydrophobic components), or
the hydrolysis resistance (suitable additives are known antioxidants).

In this way, the structural composition of the basic plastics material can be improved by nucleating agents or crystallisation formers being added to the basic plastics material. Suitable additives include, for example, finely dispersed particles. Through the addition of additives of this type, the demoulding temperature can be reached more quickly and as a result the cycle times can be reduced.

It is also possible to improve the toughness and therefore the durability of the components by adding impact strength additives (elastomer parts) such as ethylene propylene diene monomer (EPDM), other elastomers or polyethylene. Specifically, additives can be introduced which prevent the diffusion processes by covering the surface of the components. Suitable additives for this include hydrophobic additives.

It is also conceivable to introduce special marking agents such as fluorescent agents into the basic plastics material as additives which enable the clear identification of the component in question. The presence of marking agents of this type makes it possible for the user to check easily whether the component produced is an original or a copy which may not meet the required quality.

Compatibility agents may also be added as an additive to the basic plastics material for the targeted combination of two intrinsically incompatible polymers, such as PE/PP with PA. Substances known as “compatibility agents”, such as ambivalent substrates are suitable as agents.

Finally, it is conceivable to add a substance to prevent subsequent conditioning. In this way, for example, it is possible to encompass the conditioning which is normally necessary for the purposes of setting a specific moisture content in plate elements manufactured from PA plastics materials. In this way, for example, suitable additives such as polar plasticisers can act to ensure no water can be absorbed, but the properties, which normally occur in a conventionally conditioned component, are still achieved.

Examples of fillers and additives which can be added to the basic plastics material according to the invention are organic materials such as carbon fibres, wood flour, aramid fibres which are added for reinforcement and inorganic materials such as titanium dioxide, MoS2, talcum, mica, silicic acid, iron sulphite which is used to adjust the friction properties, and sodium phenylphosphinate which is added as a nucleating agent.

The fillers, additives and other supplements mentioned in the above paragraphs can be added particularly easily to the basic plastics material processed in each case if the IMC method is used to manufacture the respective component in question for a rail fixing. By using this method, the relevant fillers and additives can be introduced into the basic plastics material alone or in combination with reinforcement fibres with no problems.

According to a further embodiment of the invention, the properties of the component for a rail fixing according to the invention can be further optimised by adding a blowing agent to the basic plastics material used in each case to enable foaming. A decreased weight is achieved with a simultaneously high level of inherent stability by the basic plastics material being formed as a foam with a comparatively high number of pores at least in certain sections or in its entirety.

At the same time, through the foaming of the basic plastics material and the associated increase in volume, the time required to fill the respective forming tool in question is decreased, with the result that a reduction of the cycle time required for the manufacture of components is achieved. The foaming also results in a minimisation of the delay in solidifying the components, and depressions which may otherwise occur as a result of shrinkage caused as a result of solidification can be avoided.

The driving power enabled by the foaming process in the basic plastics material also enables long flow path lengths. Checking of the foaming process can be carried out by using the known gas counter-pressure method in which a gas pressure is used to counter the plastics material flowing into each moulding tool in order to ensure even mould filling and prevent premature foaming.

A high gas content of the molten mass with chemical and physical blowing agents leads to the formation of an integral foam structure in the interior of the moulded parts. When a structure of this type is formed, it is possible to forego the holding pressure phase which is unavoidable in conventional injection moulding. This means lower internal pressure in the tool, subsequent lower closing forces required to hold the tool and as a result a considerable reduction in wear. As a result of the reduction in the holding pressure time, it is possible to achieve shorter cycle times and thus greater productivity.

Dependent on the respective geometry of the component to be manufactured, the weight thereof can be reduced by using additives to foam the basic plastics material and the resulting porous cell structure achieved according to the invention by 15% as compared with a component formed identically, but manufactured conventionally. At the same time, the foaming saves on materials, which in turn brings with it lower unit costs.

Overall, the addition according to the invention of a foaming agent to the basic plastics material results in an equal material shrinkage and therefore in an improved part quality. The plate-shaped components for rail fixings manufactured according to the invention are suitable for the reduction in the thickness of the basic plastics material achieved by adding foaming agents, since they enable “breathing tools” which can be used to achieve highly foamed integral structures and the associated increased specific flexural strength.

Foaming agents with a physical or a chemical effect can be used for the purposes of the invention. Physical foaming agents include for example nitrogen or carbon dioxide. The known MuCell process can be used, which is for example described in the “CellForm—Schäumverfahren für das Spritzgieβen” (“CellForm foaming process for injection moulding”) brochure published by Krauss Maffei Technologies GmbH. Chemical blowing agents include for example sodium bicarbonate.

The invention is described below in greater detail by means of drawings showing exemplary embodiments.

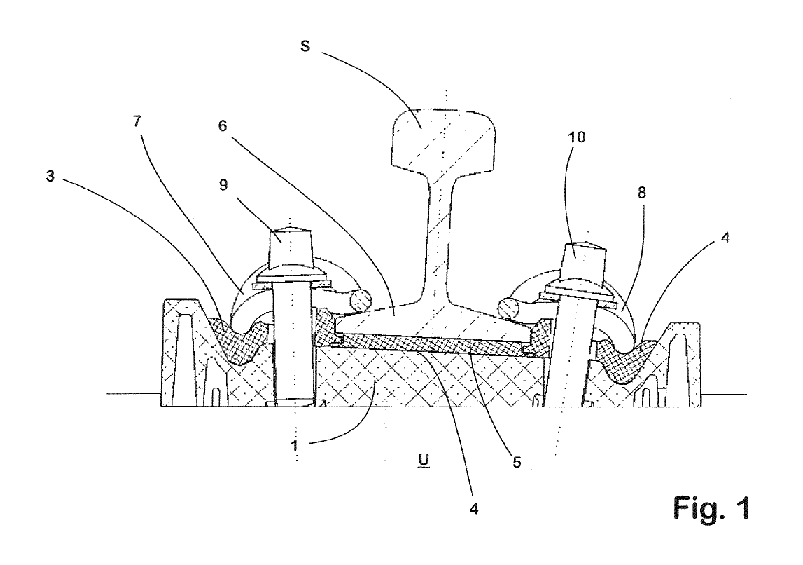

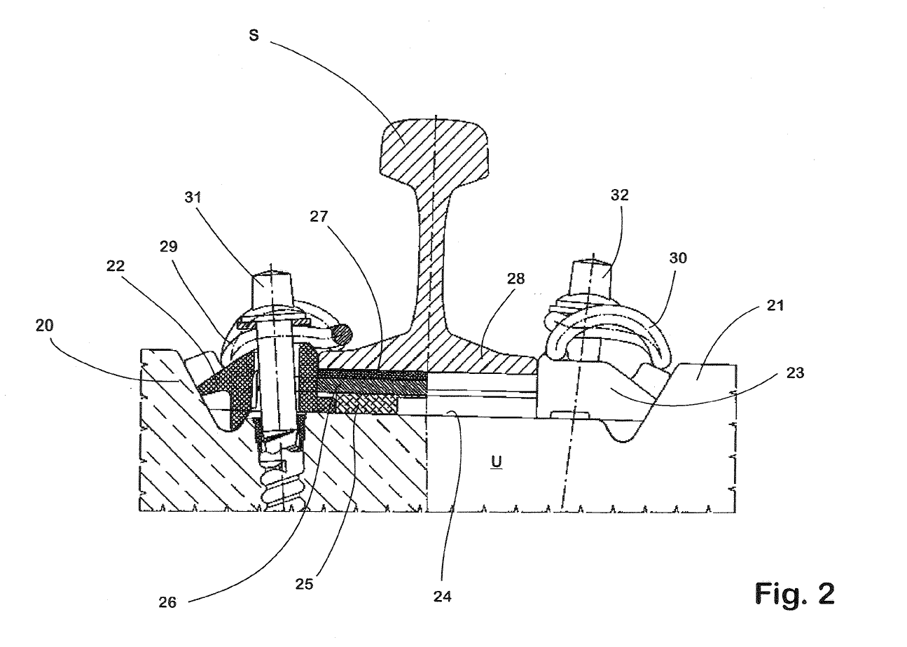

FIGS. 1 and 2 of the drawing show a schematic view and a partial section view transverse to the longitudinal extension of the relevant rail S of a conventionally constructed system for fixing a rail S.

In the first system shown in FIG. 1, a rail S is fixed onto a solid subsoil U, for example by a concrete tie. The system comprises a packing plate 1 on which two angled guide plates 2, 3 are supported. The angled guide plates 2, 3 between them define a contact surface 4 formed on the upper side of the packing plate 1, on which contact surface 4 a ply 5 consisting of elastic material lies. In turn, the foot 6 of the rail S lies on the elastic ply 5, which foot 6 is laterally adjoined to its respective bearing surface of the angled guide plates 2,3 associated with it. On each of the angled guide plates 2, 3 a W-shaped, conventionally formed spring element 7, 8 is mounted which acts with the free ends of its spring arm on the rail foot 6 and thus exerts the elastic holding force required to hold the rail S. The spring elements 7, 8 are thereby each tensioned against the subsoil U by means of a coach screw 9, 10 which is inserted through an opening in the respective angled guide plate 2, 3 and is screwed into a dowel which sits in the subsoil U and is not visible here.

The system shown in FIG. 2 for fixing the rail S is also designed in a conventional manner in terms of its components. In this way, two shoulders 20, 21 are formed into the solid subsoil U formed here as a concrete tie, on each of which shoulders 20,21 an angled guide plate 22, 23 is supported. The angled guide plates 22, 23 also between them define a contact surface 24 which is formed on the upper side of the solid subsoil U. An elastic ply 25 lies on the contact surface 24, on which in turn a pressure distribution plate 26 is laid. A second elastic ply 27 is found on the pressure distribution plate 26, on the upper side of which elastic ply the rail S stands with its rail foot 28. As in the example shown in FIG. 1, the angled guide plates 22, 23 are in lateral contact with the rail foot 28 in such a manner that they divert the transverse forces which occur when a railway vehicle drives over the rail S into the solid subsoil U. As in the exemplary embodiment shown in FIG. 1, a W-shaped spring element 29, 30, also known as a tensioning clamp, is supported on each of the angled guide plates 22, 23, which spring element 29,30 is tensioned against the subsoil U by means of a coach screw 31, 32 in each case.

The components, which are provided for fixing the rail S, “packing plate 1” and “angled guide plates 2, 3” of the rail fixing system shown in FIG. 1 and the “angled guide plate 22, 23” and the “pressure distribution plate 26” of the rail fixing system shown in FIG. 2 have each been manufactured using the IMC method from a polyamide plastics material to which glass fibres have been added to the IMC compounder used in each case as reinforcement fibres.

Conventional components manufactured from glass fibre-reinforced polyamide plastics material granules and formed in the same way were used for comparison.

In each case, the lengths of the reinforcement fibres present according to the invention by using IMC method were determined. In this way, it was possible to determine the following lengths (in μm):

| | Components | |
|---|---|---|
| | manufactured | Components produced |
| | according to the | conventionally from |
| | invention using the | plastics material |
| | IMC method | granules |
| Minimum | 18.86 | 13.60 |
| Average value | 377.19 | 175.45 |
| Maximum | 1832.99 | 629.82 |

1. A component for rail fixing systems manufactured from a fibre-reinforced plastics material comprising a basic plastics material and reinforcement fibres integrated therein, wherein it is manufactured using injection moulding compounding and the length of the reinforcement fibres is an average of at least 200 μm.

2. The component according to claim 1, wherein the length of the reinforcement fibres is greater than 350 μm on average.

3. The component according to claim 1, wherein the length of the reinforcement fibres is in the range from 15-2000 μm respectively.

4. The component according to claim 1, wherein the basic plastics material is polypropylene (PP), polyamide (PA), polyethylene terephthalate (PET), polyoxymethylene (POM), acrylonitrile-butadiene styrene (ABS), polybutylene terephthalate (PBT), polyethylene (LDPE/HDPE) or a mixture of these plastics materials.

5. The component according to claim 1, wherein the reinforcement fibres are glass fibres, aramid fibres, carbon fibres, metal fibres or ceramic fibres.

6. The component according to claim 1, wherein at least one additive is added to the basic plastics material to adjust a specific property of the fibre-reinforced plastics material.

7. The component according to claim 1, wherein the basic plastics material contains at least one filler.

8. The component according to claim 1, wherein it is plate-shaped.

9. The component according to claim 8, wherein it is a steering plate to laterally guide a rail.

10. The component according to claim 8, wherein it is a packing plate to place underneath a rail.

11. The component according to claim 8, wherein it is a spacer plate which is provided to be placed between the relevant rail to be fixed and a packing plate lying on the respective subsoil.
